(19) United States
(12) Patent Application Publication
(10) Pub. No.: US 2022/0415195 A1
(43) Pub. Date: Dec. 29, 2022

(54) METHOD FOR TRAINING COURSE RECOMMENDATION MODEL, METHOD FOR COURSE RECOMMENDATION, AND APPARATUS

(71) Applicant: BEIJING BAIDU NETCOM SCIENCE TECHNOLOGY CO., LTD., Beijing (CN)

(72) Inventors: Chao WANG, Beijing (CN); Hengshu ZHU, Beijing (CN); Peng WANG, Beijing (CN); Xin SONG, Beijing (CN)

(73) Assignee: BEIJING BAIDU NETCOM SCIENCE TECHNOLOGY CO., LTD., Beijing (CN)

(21) Appl. No.: 17/899,831

(22) Filed: Aug. 31, 2022

(30) Foreign Application Priority Data
Feb. 18, 2022 (CN) 2022101535249

(51) Int. Cl. G09B 5/02; G06N 5/02; G06N 5/04

(52) U.S. Cl. CPC G09B 5/02; G06N 5/022; G06N 5/04

(57) ABSTRACT

A method for training a course recommendation model, a method for course recommendation, and an apparatus, which relate to a field of big data and deep learning in a field of artificial intelligence technology, and can be applied to recommendation scenarios. The training method includes: obtaining a sample data set, where the sample data set includes user learning data, the user learning data includes record data and ability label data, the record data is used for representing a historical learning process of a sample user, and the ability label data is used for representing a learning ability level of the sample user, and training and generating the course recommendation model according to the user learning data, where the course recommendation model is used for recommending a course for a user, the technical effect of improving the reliability and accuracy of course recommendation is achieved.

### CROSS-REFERENCE TO RELATED APPLICATION

The present disclosure claims priority to Chinese Patent Application No. 202210153524.9, filed on Feb. 18, 2022, which is hereby incorporated by reference in its entirety.

### TECHNICAL FIELD

The present disclosure relates to a field of big data and deep learning in a field of artificial intelligence technology, which can be applied to recommendation scenarios, and in particular to a method for training a course recommendation model, a method for course recommendation, and an apparatus.

### BACKGROUND

The intelligent course recommendation technology refers to the recommendation technology of recommending personalized courses suitable for their own learning to learners who use the system in the learning management system. How to improve the accuracy of course recommendation has become an urgent problem to be solved.

In the prior art, the course recommendation technology based on course sequence relationship is adopted to realize recommendation of courses. The course sequence relationship refers to that one course is the pre-course or post-course of another course. Usually, this sequence relationship is labeled by experts in the field of education. When users choose a course, the pre-course or post-course of this course can be recommended to them.

However, the recommendation method based on the course sequence relationship depends heavily on the labeling quality of experts, while manual labeling costs a lot of money and manpower, and the accuracy is also low.

### SUMMARY

The present disclosure provided a method for training a course recommendation model, a method for course recommendation, and an apparatus, for improving the accuracy of course recommendation.

According to a first aspect of the present disclosure, a method for training a course recommendation model is provided, including:

obtaining a sample data set, wherein the sample data set includes user learning data, the user learning data includes record data and ability label data, the record data is used for representing a historical learning process of a sample user, and the ability label data is used for representing a learning ability level of the sample user; and

training and generating the course recommendation model according to the user learning data, where the course recommendation model is used for recommending a course for a user.

According to a second aspect of the present disclosure, a method for course recommendation is provided, including:

obtaining learning data of a user; and

inputting the learning data into a pre-trained course recommendation model, and outputting a course recommended to the user, where the course recommendation model is trained and generated based on the method according to the first aspect.

According to a third aspect of the present disclosure, an electronic device is provided, including:

at least one processor;

a memory connected with the at least one processor; wherein

the memory stores instructions executable by the at least one processor, and the instructions are executed by the at least one processor to enable the at least one processor to:

obtain a sample data set, where the sample data set includes user learning data, the user learning data includes record data and ability label data, the record data is used for representing a historical learning process of a sample user, and the ability label data is used for representing a learning ability level of the sample user;

train and generate the course recommendation model according to the user learning data, wherein the course recommendation model is used for recommending a course for a user.

According to a fourth aspect of the present disclosure, a non-transitory computer readable storage medium that stores computer instructions is provided, where the computer instructions are used to enable a computer to execute the method according to the first aspect.

It should be understood that the description in this section is not intended to identify key or important features of the embodiments of the present disclosure, nor is it intended to limit the scope of the present disclosure. Other features of the present disclosure will become apparent from the following description.

### BRIEF DESCRIPTION OF DRAWINGS

The accompanying drawings are used for better understanding of the solutions, and do not constitute a limitation to the present application. Among them:

FIG. 1 is a schematic diagram according to a first embodiment of the present disclosure.

FIG. 2 is a schematic diagram according to a second embodiment of the present disclosure.

FIG. 3 is a schematic diagram according to a third embodiment of the present disclosure.

FIG. 4 is a schematic diagram according to a fourth embodiment of the present disclosure.

FIG. 5 is a schematic diagram according to a fifth embodiment of the present disclosure.

FIG. 6 is a schematic diagram according to a sixth embodiment of the present disclosure.

FIG. 7 is a schematic diagram according to a seventh embodiment of the present disclosure.

FIG. 8 is a schematic diagram according to an eighth embodiment of the present disclosure.

FIG. 9 is a schematic diagram according to a ninth embodiment of the present disclosure.

FIG. 10 is a schematic diagram according to a tenth embodiment of the present disclosure.

FIG. 11 is a block diagram of an electronic device for implementing a method for training a course recommendation model and a method for course recommendation of an embodiment of the present disclosure.

### DESCRIPTION OF EMBODIMENTS

The exemplary embodiments of the present disclosure are illustrated below in conjunction with the accompanying drawings, including various details of the embodiments of the present disclosure for ease of understanding, and the embodiments should be considered as merely exemplary. Therefore, those of ordinary skill in the art should recognize that various changes and modifications can be made to the embodiments described herein without departing from the scope and spirit of the present disclosure. Likewise, for the sake of clarity and conciseness, descriptions of well-known functions and structures are omitted in the following description.

Intelligent course recommendation technology refers to the recommendation technology of recommending personalized courses suitable for their own learning to learners who use the system in the learning management system. In current Internet era, in order to make full use of a large number of online educational resources and improve learners' learning efficiency, many learning management systems are widely used in school student education and enterprise staff training. These learning management systems usually provide a large number of online courses for users to learn. School students can use the learning management systems to supplement and consolidate the required knowledge of key points of test, and enterprise employees can use the learning management system to learn and improve the required work skills. When using these learning management systems, the number of courses stored in the system not only far exceeds the number of courses that traditional education or training institutions can offer at one time, but also covers much more knowledge and skills than traditional learning scenarios. Therefore, it is difficult for users to quickly find the most suitable courses from massive resources, especially for users who have just started using the system.

In related art, the following four methods are usually used to recommend courses for users.

Method 1: recommend the same course to all users through manual labeling and expert opinions.

However, the common application scenario of this method is to promote the courses in the system on the home page of the learning management system, and the courses are selected manually, which is a non-personalized recommendation method. On the one hand, it cannot meet the personalized learning needs of different users; on the other hand, the selected courses will not change in a short time, so it can't continuously recommend courses for users.

Method 2: recommend the hottest courses in all periods or the current period to all users.

However, this method is also a non-personalized recommendation method, and there are similar problems to the Method 1.

Method 3: course recommendation technology based on course sequence relationship. The course sequence relationship refers to that one course is the pre-course or post-course of another course. Usually, this sequence relationship is labeled by experts in the field of education. When users choose a course, the pre-course or post-course of this course can be recommended to them.

However, this method depends heavily on the labeling quality of experts, while manual labeling costs a lot of money and manpower, and the accuracy cannot be guaranteed, which makes it difficult to guarantee the quality of recommendation, and at the same time, it is time-consuming and laborious. Moreover, the recommendation results are completely limited to the course categories similar to the course that the user has selected, especially in the case of cold start scenarios, that is, the user has not seen or only seen a few courses, it is difficult to recommend appropriate courses.

Method 4: collaborative filtering recommendation technology. Collaborative filtering recommendation refers to recommending similar courses to similar users. Because users with higher similarity have a higher probability of learning similar courses, they can recommend similar courses to these users. Generally, there are two sources of similarity calculation. One is to calculate the similarity according to the user's class record, and the other is to calculate the similarity according to additional information, such as the user's resume and course introduction.

However, this method only recommends similar courses to users, but does not comprehensively consider current ability status and learning demand preference of users, which leads to the problem of low accuracy and reliability of recommendation.

In order to avoid at least one of the above technical problems, the inventor of the present disclosure obtained the inventive concept of the present disclosure through creative labor: training and generating a course recommendation model by combining record data and ability label data, so as to recommend courses for users based on the course recommendation model, where the record data is data that can represent historical learning process of sample users, and the ability label data is data that can represent learning ability level.

Based on the above inventive concept, the present disclosure provides a method for training a course recommendation model, a method for course recommendation, and an apparatus, which relate to a field of big data and deep learning in a field of artificial intelligence technology, and can be applied to recommendation scenarios to achieve the technical effect of improving the accuracy and reliability of course recommendation.

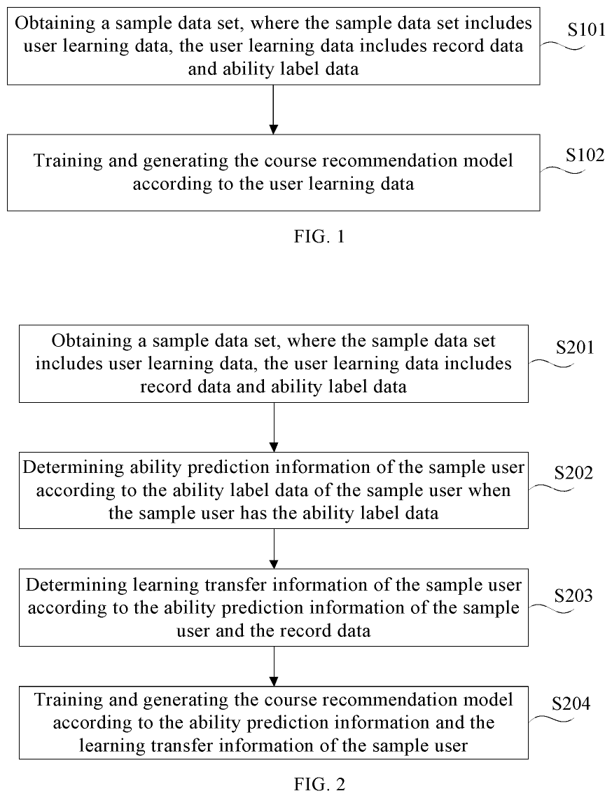

FIG. 1 is a schematic diagram according to a first embodiment of the present disclosure. As shown in FIG. 1, the method for training a course recommendation model of the embodiment of the present disclosure includes the following.

S101: obtaining a sample data set, where the sample data set includes user learning data, the user learning data includes record data and ability label data, the record data is used for representing a historical learning process of a sample user, and the ability label data is used for representing a learning ability level of the sample user.

Illustratively, the executive body of the present embodiment can be an apparatus for training a course recommendation model (hereinafter referred to as training apparatus), and the training apparatus can be a server (such as a cloud server or a local server), a terminal device, a computer, a processor, a chip, etc., which are not limited in the present embodiment.

The sample data set includes at least data of two dimensions, data of one dimension is the record data, that is, the data of learning records of sample users, such as learning time, learning courses, and learning chapters, etc., data of another dimension is the ability label data, that is, the data of learning ability of the sample users, such as strong learning ability, general learning ability and weak learning ability.

It should be noted that the number of samples are not limited in the present embodiment, and can be set based on requirements, historical records, tests and the like.

For example, a relatively large number of sample data can be selected for training with high recommendation quality requirements, while a relatively small number of sample data can be selected for training with general recommendation quality requirements.

Moreover, for a certain sample user, the sample data set may only include the record data of the sample user, or may only include the ability label data of the sample user, or may include both the record data of the sample user and the ability label data of the sample user.

S102: training and generating the course recommendation model according to the user learning data, where the course recommendation model is used for recommending a course for a user.

The present embodiment does not limit to method of training the course recommendation model based on the user learning data. For example, a basic network model can be selected, the user learning data can be input into the basic network model, and the basic network model can be trained to generate the course recommendation model. Moreover, the present embodiment does not limit the type and configuration information of the basic network model.

Based on the above analysis, the embodiment of the present disclosure provides a method for training a course recommendation model, includes: obtaining a sample data set, where the sample data set includes user learning data, the user learning data includes the record data and the ability label data, the record data is used for representing a historical learning process of the sample user, and the ability label data is used for representing a learning ability level of the sample user, training and generating a course recommendation model according to the user learning data, where the course recommendation model is used for recommending the courses for the user. In the present embodiment, the technical features of obtaining the learning record data and the ability label data, and training and generating the course recommendation model based on the learning record data and the ability label data, then recommending the course for the user based on the course recommendation model are introduced, which avoids disadvantages of inability to meet the personalized needs of users and low reliability in related art. By recommending the course for the user in combination with the ability label data, the technical effect of recommending the course for the user in combination with the learning ability of the user, meeting the personalized needs of users, and improving the reliability and accuracy of course recommendation is achieved.

FIG. 2 is a schematic diagram according to a second embodiment of the present disclosure. As shown in FIG. 2, the method for training a course recommendation model of the embodiment of the present disclosure includes the following.

S201: obtaining a sample data set, where the sample data set includes user learning data, the user learning data includes record data and ability label data, the record data is used for representing a historical learning process of a sample user, and the ability label data is used for representing a learning ability level of the sample user.

It should be noted that the technical features of the present embodiment which are the same as those of the above embodiments will not be elaborated in the present embodiment.

In some embodiments, the record data and the ability label data can be represented by matrix.

For the record data:

A user identity (ID) is assigned to each sample user, and a course identity (ID) is assigned to each course, which is converted into a form of a 0-1 matrix for storage. When the matrix is large, it can be stored as a sparse matrix in a triple form.

For example, the record data can be expressed as R ∈ [symbol] ^{N×M}, where N is the number of the sample users and M is the number of the courses. If a sample user i has learned a course j, it is expressed as Rᵢⱼ=1; otherwise, it is expressed as Rᵢⱼ=0, that is, the record data can be expressed by a 0-1 matrix.

In some embodiments, high-dimensional sparse matrix R can be mapped to two matrices with low dimensions to decompose the high-dimensional sparse matrix R.

For example, a high-dimensional sparse matrix R can be decomposed into a matrix of learning preference (such as preference in learning time and preference in learning direction, etc.)

of sample users and a matrix of course attributes (such as types of the courses and professional degrees of the courses, etc.).

The matrix of learning preference can be expressed as U ∈ [symbol] ^{K×N}, and the matrix of course attributes can be expressed as V ∈ [symbol] ^{K×M}.

For the ability label data:

The ability label data can be collected from many aspects, such as extracting the ability label data from text materials provided by the sample users, predicting the ability label data from the courses learned by the sample users in the past, and so on.

After the ability label data is collected, the ability label data can be preprocessed, such as cleaning the ability label data, merging some synonymous ability label data, and eliminating the ability label data that only a few sample users (such as one or two sample users) have, and so on, so as to improve the effectiveness and reliability of the ability label data in the sample set and avoid interference of noise data.

After preprocessing the ability label data, an identity can be given to each ability label data, and the ability label data is converted into a form of a standard 0-1 matrix for storage.

For example, the matrix of the ability label data can be expressed as X ∈ [symbol] ^{N×E}, where E is the type of ability.

S202: determining ability prediction information of the sample user according to the ability label data of the sample user when the sample user has the ability label data, where the ability prediction information represents learning ability of the sample user for the course.

In some embodiments, determining the ability prediction information of the sample user according to the ability label data of sample users can include the following steps.

Step 1: encoding the ability label data of the sample user to obtain coding information.

Step 2: performing a full connection processing on the coding information to obtain mean information and variance information, and performing a sampling processing on the mean information and the variance information to obtain the ability prediction information of the sample user.

For example, the ability label data of the sample user can be encoded by an encoder. Specifically, the encoder can be a variational auto-encoder, which includes two neural network components, namely an encoder and a decoder. The encoder is composed of Multi-layer Perception Network. Each layer of the network processes the data transmitted from the previous layer of the network and then transmits it to the next layer. The input of the first layer is the ability label data of the sample user, such as ability label data Xᵢ of sample user i.

Among them, each layer of the network hₗ has two parameters, namely a weight coefficient matrix Wₗ and an offset vector bₗ. The two parameters obey normal distribution as shown in equation 1, which is:

W_{l,*m}˜ [symbol] (0, λ_{w}⁻¹I_{K}_{ₗ}), bₗ˜ [symbol] (0, λ_{b}⁻¹I_{K})

For layer l of the network, there are:

h_{l,i*}˜ [symbol] (Sig(h_{l-1,i*}Wₗ+bₗ), λₛ⁻¹I_{K})

Among them,

$$S i g ( x ) = \frac{1}{1 + {e}^{- x}}$$

is a Sigmoid function, I_{K} refers to identity matrix of K dimension, b and λ are preset parameters, and m is the sample user.

The final output of the encoder goes through the fully connected layer network to obtain the mean information μₛ_{ᵢ} and the variance information Σₛ_{ᵢ} respectively:

μₛ_{ᵢ}˜ [symbol] (h_{L,i*}W_{μ}+b_{μ}, λₛ⁻¹I_{K})

Σₛ_{ᵢ}˜ [symbol] (h_{L,i*}W_{Σ}+b_{Σ}, λₛ⁻¹I_{K})

Sampling the mean information and variance information to obtain the ability prediction information sᵢ˜ [symbol] (μₛ_{ᵢ}, Σₛ_{ᵢ}) of the sample user.

In the present embodiment, the ability prediction information of the sample user is determined by combining coding and sampling, which can improve the efficiency of data processing.

S203: determining learning transfer information of the sample user according to the ability prediction information of the sample user and the record data, where the learning transfer information represents a learning change of the sample user.

Based on the above analysis, for a certain sample user, the sample data set may include both the record data of the sample user and the ability label data of the sample user, then the ability prediction information of the sample user can be predicted based on the ability label data of the sample user, that is, the predicted learning ability of the sample user can be obtained.

Accordingly, according to the ability prediction information and the record data of the sample user, the learning change of the sample user is predicted, that is, the learning transfer information of the sample user is predicted.

In some embodiments, S203 can include: determining learning transfer requirement information of the sample user under respective learning task according to the ability prediction information, and determining the learning transfer information of the sample user according to the record data and the learning transfer requirement information.

Illustratively, the ability prediction information of the sample user is known, that is, the learning ability of the sample user is known, and according to this learning ability, situation of the sample user can cross from current course to another course (i.e., learning transfer requirement information) or cross from one chapter of the course to another chapter of the course (i.e., learning transfer requirement information) under the learning ability can be predicted. Then the learning transfer information of the sample user is determined according to the record data and the learning transfer requirement information, to determine the learning transfer information of the sample user from multiple dimensions, so as to achieve the technical effect of making the determined learning transfer information of the sample user have high accuracy and reliability.

In some embodiments, the determining the learning transfer requirement information of the sample user under the respective learning task according to the ability prediction information comprises the following.

Obtaining transfer information among different learning tasks under the respective learning task, and determining the learning transfer requirement information of the sample user according to the transfer information and the ability prediction information.

For example, the transfer information between different learning tasks can be expressed by the transfer variable dₜ ∈ [symbol] ^{K}, then the learning transfer requirement information of the sample user can be expressed by the transferred requirement variable zᵢₜ=sᵢ+dₜ, accordingly, the transfer matrix Zᵢ=(zᵢ₁, . . . , z_{iT}) can be determined.

The learning transfer requirement information of the sample user can be expressed by the transfer probability ωᵢ=softmax(Zᵢ^{T}VR_{i*}^{T}), accordingly, the learning transfer information of the sample user can be expressed by G(sᵢ)=Zᵢωᵢ.

It is worth noting that, in the present embodiment, by obtaining the transfer information, the learning change of the sample user among different learning tasks under the respective learning tasks (such as learning courses and learning chapters, etc.) are determined, and the learning transfer requirement information of the sample user is determined according to the change and the learning ability of the sample user (i.e., the ability prediction information), so that the learning transfer requirement information of the sample user meets not only the learning ability of the sample user, but also general learning change rules, so as to achieve the technical effect of improving the accuracy and reliability of the determined learning transfer requirement information of the sample user.

S204: training and generating the course recommendation model according to the ability prediction information and the learning transfer information of the sample user.

In some embodiments, S204 can include the following steps.

Step 1: decoding the ability prediction information of the sample user to obtain probability distribution information of the ability label data.

Illustratively, in combination with the above analysis, the ability prediction information can be obtained after the encoding and sampling processing, and then the ability prediction information can be decoded, and the decoding processing can also be completed through a fully-connected network. However, the decoding processing can be a single-layered neural network h_{gen}, and only the weight parameter W_{gen} can be needed to perform the decoding process based on h_{gen,i*}=(βθᵢ).

Among them, β and θᵢ are the column-by-column softmax forms of sᵢ and W_{gen}, respectively. Through the softmax function, the original vector can be normalized. θᵢ represents the probability distribution of sample user i on the learning ability of K dimensions, and the k-th column of β represents the probability distribution information of each ability label data on the k-th learning ability.

Among them, the probability distribution information of the ability label data obeys polynomial distribution Xᵢ˜Multinomial(h_{gen,i*}).

Step 2: determining a loss function of the ability label data according to the probability distribution information, and determining a loss function of the record data according to the learning transfer information of the sample user.

Step 3: training and generating the course recommendation model according to the loss function of the ability label data and the loss function of the record data.

In combination with the above analysis, the course recommendation model can be represented based on \hat{R}ᵢⱼ=G(μₛ_{ᵢ})^{T}vⱼ.

In the present embodiment, the course recommendation model is trained by adopting the parameters of two dimensions (i.e., the record data and the ability label data) and by combining loss function of the two dimensions, so as to improve the reliability and effectiveness of the training process by fully considering the influence of the parameters of the respective dimension on the training course recommendation model, and then achieve the technical effect of improving the accuracy and reliability of course recommendation model.

It is worth noting that, in the present embodiment, in the scenario where the sample users have both record data and ability label data, the ability prediction information and learning transfer information are respectively determined to generate the course recommendation model based on the ability prediction information and learning transfer information, which can improve the reliability and effectiveness of training, and further achieve the technical effect of improving the accuracy and reliability of course recommendation when making course recommendations for users based on the course recommendation model.

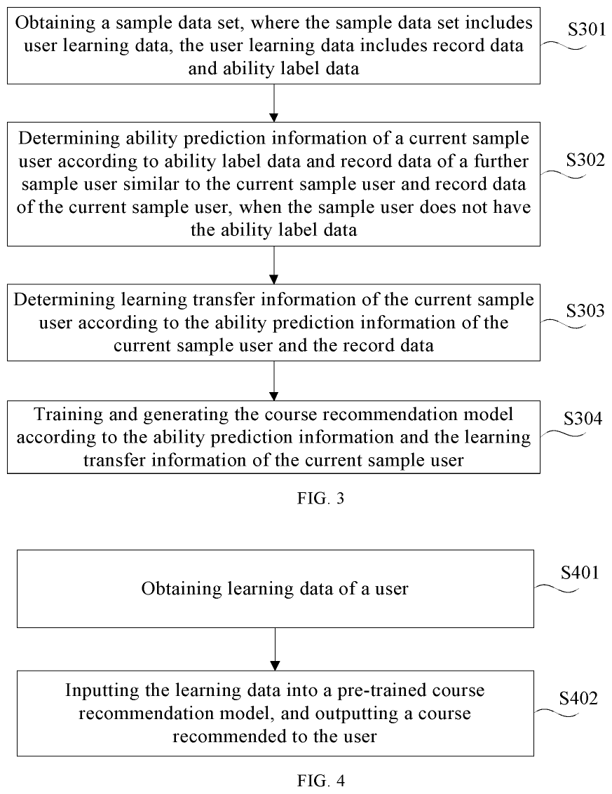

In the second embodiment, the method that sample users have both record data and ability label data to train the course recommendation model is described in detail. In combination with the above analysis, it can be known that in other embodiments, the sample users may only have the record data. In order to facilitate readers to understand the implementation principle of the present embodiment, it will be described with reference to FIG. 3.

FIG. 3 is a schematic diagram according to a third embodiment of the present disclosure. As shown in FIG. 3, the method for training a course recommendation model of the embodiment of the present disclosure includes the following.

S301: obtaining a sample data set, where the sample data set includes user learning data, the user learning data includes record data and ability label data, the record data is used for representing a historical learning process of a sample user, and the ability label data is used for representing a learning ability level of the sample user.

For the same reason, the technical features of the present embodiment which are the same as those of the above embodiments will not be elaborated in the present embodiment.

S302: determining ability prediction information of a current sample user according to ability label data and record data of a further sample user similar to the current sample user and record data of the current sample user, when the sample user does not have the ability label data.

The “similarity” in the further sample user who is similar to the current sample user can include similarities in user attributes, such as similar age, same gender, similar personality, similar work and similar interests. It can also include similarities in learning attributes, such as similar learning courses, similar learning time, similar learning progress, etc.

In the present embodiment, if the current sample user has record data but does not have ability label data, the ability of the current sample user can be predicted by combining the data of the further sample user similar to the current sample user, so as to obtain the ability prediction information of the current sample user. In this way, the amount of data in the sample data set can be increased, so that the course recommendation model can be trained based on a relatively sufficient amount of data, to achieve the technical effect of improving the comprehensive effectiveness and reliability of training.

In some embodiments, S302 can include the following steps.

Step 1: extracting information related to the learning ability according to the record data of the current sample user.

Step 2: determining the ability prediction information of the current sample user according to the record data and the ability label data of the further sample user, the record data of the current sample user, and the extracted information related to the learning ability.

The information related to the learning ability includes, but is not limited to, learning time, time schedule, difficulty degree of learning courses, etc.

In the present embodiment, for the current sample user without ability label data, the information related to the learning ability of the current sample user is determined based on the record data of the current sample user firstly, so that the ability prediction information of the current sample user is determined based on the extracted information and the record data and the ability label data of the further sample user, which not only considers the possible interaction between the further sample user and the current sample user, but also considers the actual learning situation of the current user, and can achieve the technical effect of improving the accuracy and reliability of the determined ability prediction information of the current sample user.

In some embodiments, step 2 can include the following steps.

Substep 1: determining attention influence information of the further sample user on the current sample user according to the record data of the further sample user, the record data of the current sample user and the extracted information related to the learning ability, where the attention influence information is used for representing an influence relationship of the ability label data of the further sample user to ability label data of the current sample user.

Substep 2: determining the ability prediction information of the current sample user according to the attention influence information and the ability label data of the further sample user.

In the present embodiment, by determining the influence of the further sample user on the current sample user in ability label data (i.e., attention influence information), the ability prediction information of the current sample user is determined based on the influence, thus by fully considering the influence of the further sample user similar to the current sample user, the technical effect of improving the accuracy and reliability of the determined ability prediction information of the current sample user is achieved.

In some embodiments, the substep 2 can include: determining ability prediction information of the further sample user according to the ability label data of the further sample user, and determining the ability prediction information of the current sample user according to the attention influence information and the ability prediction information of the further sample user.

For example, the current sample user i does not have the ability label data, and the further sample user similar to the current sample user i is sample user c.

It should be understood that the number of the further sample user can be one or multiple. The present embodiment only exemplary explanated by taking the number of the further sample user as one an example, and cannot be understood as a limitation to the further sample user.

The matrix of the record data of the current sample user i is R_{i*}, and a linear change with a weight matrix parameter Wₐ is performed on R_{i*} to reduce redundant information and obtain a key feature.

In some embodiments, the attention influence information can be determined by equation 2, which is:

sᵢ=Σ_{c∈N}_{ᵢ}_{∩I}_{₁}ê_{ic}s_{c},

Among them,

$${\hat{e}}_{i c} = \frac{exp \{ {e}_{ic} \}}{{\sum }_{{c}^{′} ∈ {N}_{i} ∩ {I}_{1}} exp \{ {e}_{{ic}^{′}} \}} ,$$

e_{ic}=LeakyReLU(δ^{T}(WₐR_{i*}|WₐR_{c*})), LeakyReLU(x) represents an activation function of LeakyReLU, | represents splicing operation of two vectors, δ is a preset parameter vector.

It is worth noting that, in the present embodiment, the ability prediction information of the current sample user is determined by combining the attention influence information and the ability prediction information of the further sample user, and the influence of the further sample user on the current sample user in the learning ability can be considered by combining the two dimensions, so as to achieve the technical effect of determining the ability prediction information of the current sample user more comprehensively and reliably.

S303: determining learning transfer information of the current sample user according to the ability prediction information of the current sample user and the record data, where the learning transfer information represents a learning change of the current sample user.

S304: training and generating the course recommendation model according to the ability prediction information and the learning transfer information of the current sample user.

FIG. 4 is a schematic diagram according to a fourth embodiment of the present disclosure. As shown in FIG. 4, the method for course recommendation of the embodiment of the present disclosure includes the following.

S401: obtaining learning data of a user.

Illustratively, the executive body of the present embodiment can be an apparatus for course recommendation, which can be same apparatus as the training apparatus or different apparatus from the training apparatus, which are not limited in the present embodiment.

S402: inputting the learning data into a pre-trained course recommendation model, and outputting a course recommended to the user, where the course recommendation model is trained and generated based on the method according to any one of the embodiments above.

Based on the above analysis, the course recommendation model is generated by training on basis of the record data and the ability label data, which takes into account not only the relevant information of learning content of the sample users, but also the relevant information of the learning ability of the sample users. Therefore, when recommending courses for users based on the course recommendation model, the courses recommended for users can fully consider various factors such as learning interest and learning ability of users, thus can achieve the technical effect of making course recommendations pertinently for users based on the learning ability of users, and then improving the accuracy and reliability of course recommendation.

In some embodiments, in the initial stage (also called the cold start stage), when user i does not have the user learning data, such as does not have record data, sᵢ can be can be used instead of uᵢ to complete the course recommendation. Alternatively, the ωᵢ of the sample user can be replaced by average value of ω of the further sample user (some sample users or all sample users).

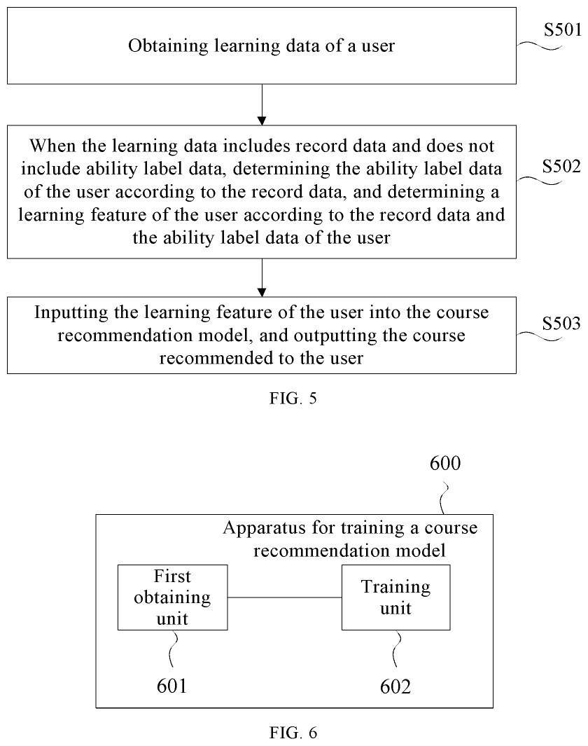

FIG. 5 is a schematic diagram according to a fifth embodiment of the present disclosure. As shown in FIG. 5, the method for course recommendation of the embodiment of the present disclosure includes the following.

S501: obtaining learning data of a user.

S502: when the learning data includes record data and does not include ability label data, determining the ability label data of the user according to the record data, and determining a learning feature of the user according to the record data and the ability label data of the user.

S503: inputting the learning feature of the user into the course recommendation model, and outputting the course recommended to the user.

In some embodiments, if the learning data only includes record data, the learning feature can be determined according to the record data. Reference can be made in detail to the description of the generating of the matrix of the record data in the above embodiments, will not be repeated here. And inputting the learning feature into the course recommendation model, and outputting the course recommended to the user.

In some embodiments, if the learning data only includes record data, the ability label data can be determined according to the record data. For example, the ability label data is determined according to duration of user learning a course, if the duration of learning a course is relatively long, it can be determined that the ability label data represents general learning ability of the user, if the duration of learning a course is relatively short, it can be determined that the ability label data represents strong learning ability of the user, and so on, which will not be listed here.

For the same reason, based on the method in the above embodiment, the matrix of the record data and the matrix of the ability label data can be determined, to determine the learning feature of the user, then inputting the learning feature of the user into the course recommendation model, and outputting the course recommended to the user.

FIG. 6 is a schematic diagram according to a sixth embodiment of the present disclosure, As shown in FIG. 6, the apparatus 600 for training a course recommendation model of the embodiment of the present disclosure includes:

a first obtaining unit 601, configured to obtain a sample data set, where the sample data set includes user learning data, the user learning data includes record data and ability label data, the record data is used for representing a historical learning process of a sample user, and the ability label data is used for representing a learning ability level of the sample user; and

a training unit 602, configured to train and generate the course recommendation model according to the user learning data, where the course recommendation model is used for recommending a course for a user.

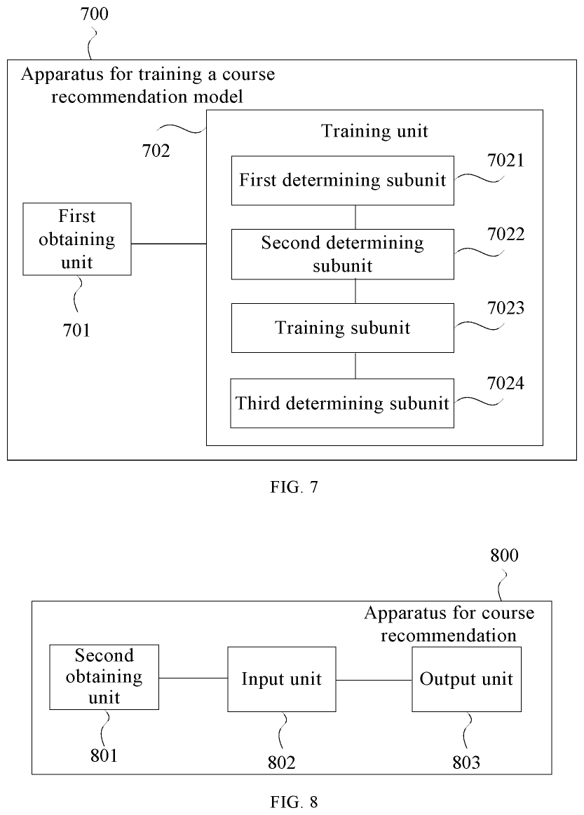

FIG. 7 is a schematic diagram according to a seventh embodiment of the present disclosure, As shown in FIG. 7, the apparatus 700 for training a course recommendation model of the embodiment of the present disclosure includes:

a first obtaining unit 701, configured to obtain a sample data set, where the sample data set includes user learning data, the user learning data includes record data and ability label data, the record data is used for representing a historical learning process of a sample user, and the ability label data is used for representing a learning ability level of the sample user; and

a training unit 702, configured to train and generate the course recommendation model according to the user learning data, where the course recommendation model is used for recommending a course for a user.

Referring to FIG. 7, in some embodiments, the training unit 702 includes:

a first determining subunit 7021, configured to determine ability prediction information of the sample user according to the ability label data of the sample user, when the sample user has ability label data, where the ability prediction information represents learning ability of the sample user for the course.

In some embodiments, the first determining subunit 7021 includes:

an encoding module, configured to encode the ability label data of the sample user to obtain coding information;

a processing module, configured to perform a full connection processing on the coding information to obtain mean information and variance information; and

a sampling module, configured to perform A sampling processing on the mean information and the variance information to obtain the ability prediction information of the sample user.

A second determining subunit 7022, configured to determine learning transfer information of the sample user according to the ability prediction information of the sample user and the record data, where the learning transfer information represents a learning change of the sample user.

In some embodiments, the second determining subunit 7022 includes:

a second determining module, configured to determine learning transfer requirement information of the sample user under respective learning task according to the ability prediction information.

In some embodiments, the second determining module includes:

an obtaining submodule, configured to obtain transfer information among different learning tasks under each learning task; and

a third determining submodule, configured to determine the learning transfer requirement information of the sample user according to the transfer information and the ability prediction information.

A third determining module, configured to determine the learning transfer information of the sample user according to the record data and the learning transfer requirement information.

A training subunit 7023, configured to train and generate the course recommendation model according to the ability prediction information and the learning transfer information of the sample user.

In some embodiments, the training subunit 7023 includes:

a decoding module, configured to decode the ability prediction information of the sample user to obtain probability distribution information of the ability label data;

a fourth determining module, configured to determine a loss function of the ability label data according to the probability distribution information, and determining a loss function of the record data according to the learning transfer information of the sample user; and

a training module, configured to train and generate the course recommendation model according to the loss function of the ability label data and the loss function of the record data.

A third determining subunit 7024, configured to determine ability prediction information of a current sample user according to ability label data and record data of a further sample user similar to the current sample user and record data of the current sample user, when the sample user does not have the ability label data.

In some embodiments, the third determining subunit 7024 includes:

an extraction module, configured to extract information related to the learning ability according to the record data of the current sample user;

a first determining module, configured to determine the ability prediction information of the current sample user according to the record data and the ability label data of the further sample user, the record data of the current sample user, and the extracted information related to the learning ability.

In some embodiments, the first determining module includes:

a first determining submodule, configured to determine attention influence information of the further sample user on the current sample user according to the record data of the further sample user, the record data of the current sample user and the extracted information related to the learning ability, where the attention influence information is used for representing an influence relationship of the ability label data of the further sample user to ability label data of the current sample user; and

a second determining submodule, configured to determine ability prediction information of the current sample user according to the attention influence information and the ability label data of the further sample user.

In some embodiments, the second determining submodule is configured to: determine ability prediction information of the further sample user according to the ability label data of the further sample user, and determine the ability prediction information of the current sample user according to the attention influence information and the ability prediction information of the further sample user.

FIG. 8 is a schematic diagram according to an eighth embodiment of the present disclosure, As shown in FIG. 8, the apparatus 800 for course recommendation of the embodiment of the present disclosure includes:

a second obtaining unit 801, configured to obtain learning data of a user;

an input unit 802, configured to input the learning data into a pre-trained course recommendation model; and

an output unit 803, configured to output a course recommended to the user, where the course recommendation model is trained and generated based on the method according to any one of the embodiments above.

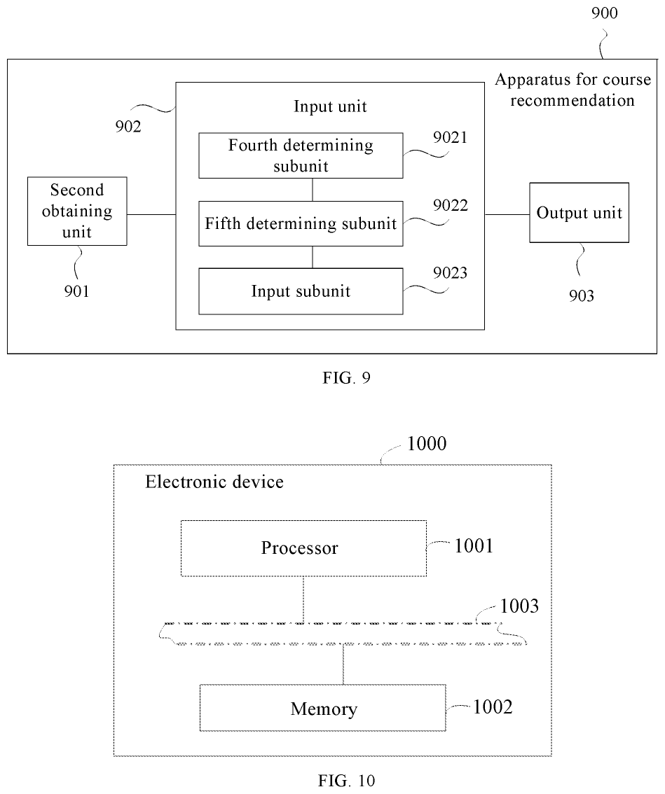

FIG. 9 is a schematic diagram according to a ninth embodiment of the present disclosure, As shown in FIG. 9, an apparatus 900 for course recommendation of the embodiment of the present disclosure includes:

a second obtaining unit 901, configured to obtain learning data of a user;

an input unit 902, configured to input the learning data into a pre-trained course recommendation model.

In some embodiments, when the learning data includes record data but does not include the ability label data, as shown in FIG. 9, the input unit 902 includes:

a fourth determining subunit 9021, configured to determine the ability label data of the user according to the record data;

a fifth determining subunit 9022, configured to determine a learning feature of the user according to the record data and the ability label data of the user; and

an input subunit 9023, configured to input the learning feature of the user into the course recommendation model.

An output unit 903, configured to output a course recommended to the user, where the course recommendation model is trained and generated based on the method according to any one of the embodiments above.

FIG. 10 is a schematic diagram according to a tenth embodiment of the present disclosure. As shown in FIG. 10, the electronic device 1000 of the present disclosure can include: the processor 1001 and the memory 1002.

The memory 1002 is configured to store programs. The memory 1002 can include volatile memory, such as random-access memory (RAM), static random-access memory (SRAM), double data rate synchronous dynamic random access memory (DDR SDRAM), etc. The memory can also include non-volatile memory, such as flash memory. The memory 1002 is configured to store computer programs (such as application programs, functional modules, etc. that implement the above method), computer instructions, etc., which can be partition stored in one or more memories 1002. And the above computer programs, computer instructions, data, etc. can be called by the processor 1001.

The above computer programs, computer instructions, etc. can be partition stored in one or more memories 1002. And the above computer programs, computer instructions, etc. can be called by the processor 1001.

The processor 1001 is configured to execute the computer program stored in the memory 1002 to realize the steps in the method related to the above embodiment.

Reference can be made in detail to related description in the embodiment of previous method.

The processor 1001 and the memory 1002 can be independent structures or integrated structures. When the processor 1001 and the memory 1002 are independent structures, the memory 1002 and the processor 1001 can be coupled by a bus 1003.

The electronic device of the present embodiment can implement the technical solution in the above method, and its specific implementation process and technical principle are the same, which will not be repeated here.

In the technical solution of the present disclosure, the collection, storage, use, processing, transmission, provision and disclosure of personal information of users are all in line with the provisions of relevant laws and regulations, and do not violate public order and good customs.

According to the embodiments of the present disclosure, the present disclosure further provides an electronic device, a readable storage medium and a computer program product.

According to an embodiment of the present disclosure, the present disclosure further provides a computer program product, and the computer program product includes a computer program, where the computer program is stored in a readable storage medium. At least one processor of an electronic device can read the computer program from a readable storage medium, and the at least one processor executes the computer program so that the electronic device executes the solution provided by any of the above embodiments.

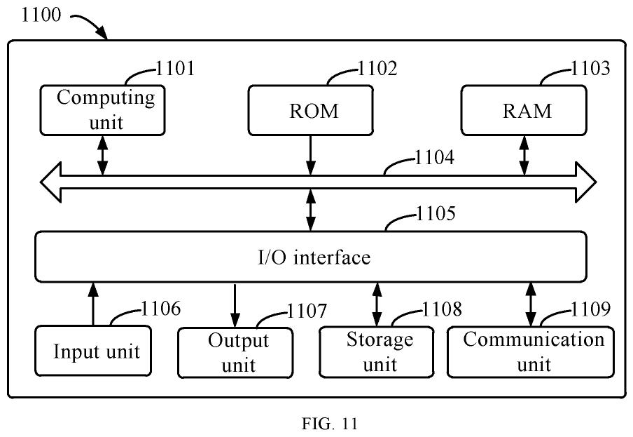

FIG. 11 shows a schematic block diagram of an electronic device 1100 that can be used to implement the method for training a course recommendation model and the method for course recommendation of the embodiments of the present disclosure. The electronic device is intended to represent various forms of digital computers, such as laptop computers, desktop computers, workstations, personal digital assistants, servers, blade servers, mainframe computers and other suitable computers. The electronic device can also represent various forms of mobile devices, such as personal digital assistants, cellular telephones, smart phones, wearable devices and other similar computing devices. The components shown herein, their connections and relationships and their functions are merely examples and are not intended to limit the implementations of the disclosure described and/or claimed herein.

As shown in FIG. 11, the electronic device 1100 includes a computing unit 1101, which can execute various appropriate actions and processes according to a computer program stored in a read-only memory (ROM) 1102 or a computer program loaded into a random access memory (RAM) 1103 from a storage unit 1108. In the RAM 1103, various programs and data required for operation of the device 1100 can also be stored. The computing unit 1101, the ROM 1102 and the RAM 1103 are connected to each other through a bus 1104. An input/output (I/O) interface 1105 is also connected to the bus 1104.

Multiple components in the device 1100 are connected to the I/O interface 1105, including: an input unit 1106, such as a keyboard, a mouse, etc.; an output unit 1107, such as various types of displays, speakers, etc.; a storage unit 1108, such as a magnetic disk, an optical disk, etc.; and a communication unit 1109, such as a network card, a modem, a wireless communication transceiver, etc. The communication unit 1109 allows the device 1100 to exchange information/data with other devices over a computer network such as the Internet and/or various telecommunication networks.

The computing unit 1101 can be various general-purpose and/or special-purpose processing components having processing and computing capabilities. Some examples of the computing unit 1101 include, but are not limited to, a central processing unit (CPU), a graphics processing unit (GPU), various specialized artificial intelligence (AI) computing chips, various computing units to operate machine learning model algorithms, a digital signal processor (DSP) and any suitable processor, controller, microcontroller, etc. The computing unit 1101 performs methods and processes described above, such as a method for training a course recommendation model and course recommendation. For example, in some embodiments, the method for training a course recommendation model and course recommendation may be implemented as a computer software program tangibly embodied on a machine-readable medium, such as the storage unit 1108. In some embodiments, part or entirety of the computer program can be loaded and/or mounted to the device 1100 via the ROM 1102 and/or the communication unit 1109. One or more steps of the method for training a course recommendation model and course recommendation described above can be performed when the computer program is loaded to the RAM 1103 and executed by the computing unit 1101. Alternatively, in other embodiments, the computing unit 1401 can be configured to execute the method for training a course recommendation model and course recommendation by any other suitable means (e.g., by means of firmware).

Various embodiments of the systems and techniques described herein can be implemented in digital electronic circuitry systems, integrated circuit systems, field programmable gate arrays (FPGA), application specific integrated circuits (ASIC), application specific standard products (ASSP), system-on-chip systems (SOC), complex programmable logic devices (CPLD), computer hardware, firmware, software and/or a combination thereof. These various embodiments can include being embodied in one or more computer programs which can be executed and/or interpreted on a programmable system including at least one programmable processor, and the programmable processor can be a special-purpose or general-purpose programmable processor, can receive data and instructions from a storage system, at least one input device and at least one output device and transmit data and instructions to the storage system, the at least one input device and the at least one output device.

Program instructions for implementing the methods of the present disclosure can be written in any combination of one or more programming languages. These program instructions can be provided to a processor or controller of a general-purpose computer, a special-purpose computer or other programmable data processing apparatus, so that the program instructions, when executed by the processor or controller, enable the functions/operations specified in the flowcharts and/or block diagrams to be implemented. The program instructions can be executed entirely on a machine, partly on a machine, and as a stand-alone software package be executed partly on a machine and partly on a remote machine or entirely on a remote machine or server.

In the context of the present disclosure, a machine-readable medium can be a tangible medium that may contain or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination of the foregoing. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device or any suitable combination of the above.

To provide interaction with a user, the systems and techniques described herein may be implemented on a computer having a display device (e.g., a CRT (cathode ray tube) or LCD (liquid crystal display) monitor) for displaying information to the user; and a keyboard and pointing device (e.g., a mouse or trackball) through which the user can provide input to the computer. Other kinds of devices may also be used to provide interaction with a user; for example, feedback provided to the user may be any form of sensory feedback (e.g., visual feedback, auditory feedback or tactile feedback); and input from the user may be received in any form (including acoustic input, voice input or tactile input).

The systems and techniques described herein can be implemented in a computing system including a background component (e.g., a data server), or a computing system (e.g., an application server) including a middleware component, or a computing system including a front-end component (e.g., a user computer having a graphical user interface or web browser, a user may interact with implementations of the systems and techniques described herein through the graphical user interface or the web browser), or a computing system in any combination of such background component, middleware component or front-end component. Components of the system may be interconnected by any form or medium of digital data communication (e.g., a communication network). Examples of the communication network include a local area network (LAN), a wide area network (WAN) and the Internet.

The computer system can include a client and a server. The client and server are generally remote from each other and typically interact through a communication network. A relationship between a client and a server is generated by computer programs running on respective computers and having a client-server relationship to each other. The server can be a cloud server, also referred to as a cloud computing server or a cloud host, and is a host product in a cloud computing service system, so as to solve the defects of huge management difficulty and weak service expansibility in a conventional physical host and a VPS service (“Virtual Private Server”, or simply referred to as “VPS”). The server may also be a server of a distributed system or a server incorporating a blockchain.

It should be understood that the steps may be reordered, added or deleted using the various forms of processes shown above. For example, the steps written in the present disclosure may be executed in parallel, in sequential order or in different orders, as long as the desired results of the technical solutions provided by the present disclosure can be realized, which is not limited herein.

The above specific embodiments do not constitute a limitation on the protection scope of the present disclosure. It should be understood by those skilled in the art that various modifications, combinations, sub-combinations and substitutions may be made according to design requirements and other factors. Any modifications, equivalent substitutions and improvements made within the spirit and principle of the present disclosure are intended to be included in the protection scope of the present disclosure.

What is claimed is:

1. A method for training a course recommendation model, comprising:
obtaining a sample data set, wherein the sample data set comprises user learning data, the user learning data comprises record data and ability label data, the record data is used for representing a historical learning process of a sample user, and the ability label data is used for representing a learning ability level of the sample user; and
training and generating the course recommendation model according to the user learning data, wherein the course recommendation model is used for recommending a course for a user.

2. The method according to claim 1, wherein training and generating the course recommendation model according to the user learning data comprises:
determining ability prediction information of the sample user according to the ability label data of the sample user when the sample user has the ability label data, wherein the ability prediction information represents learning ability of the sample user for the course;
determining learning transfer information of the sample user according to the ability prediction information of the sample user and the record data, wherein the learning transfer information represents a learning change of the sample user; and
training and generating the course recommendation model according to the ability prediction information and the learning transfer information of the sample user.

3. The method according to claim 2, further comprising:
determining ability prediction information of a current sample user according to ability label data and record data of a further sample user similar to the current sample user and record data of the current sample user, when the sample user does not have the ability label data.

4. The method according to claim 3, wherein determining ability prediction information of the current sample user according to the ability label data and the record data of the further sample user similar to the current sample user and the record data of the current sample user comprises:
extracting information related to the learning ability according to the record data of the current sample user; and
determining the ability prediction information of the current sample user according to the record data and the ability label data of the further sample user, the record data of the current sample user, and the extracted information related to the learning ability.

5. The method according to claim 4, wherein determining the ability prediction information of the current sample user according to the record data and the ability label data of the further sample user, the record data of the current sample user, and the extracted information related to the learning ability comprises:
determining attention influence information of the further sample user on the current sample user according to the record data of the further sample user, the record data of the current sample user and the extracted information related to the learning ability, wherein the attention influence information is used for representing an influence relationship of the ability label data of the further sample user to ability label data of the current sample user; and
determining the ability prediction information of the current sample user according to the attention influence information and the ability label data of the further sample user.

6. The method according to claim 5, wherein determining the ability prediction information of the current sample user according to the attention influence information and the ability label data of the further sample user comprises:
determining ability prediction information of the further sample user according to the ability label data of the further sample user; and
determining the ability prediction information of the current sample user according to the attention influence information and the ability prediction information of the further sample user.

7. The method according to claim 2, wherein determining the learning transfer information of the sample user according to the ability prediction information of the sample user and the record data comprises:
determining learning transfer requirement information of the sample user under respective learning task according to the ability prediction information, and determining the learning transfer information of the sample user according to the record data and the learning transfer requirement information.

8. The method according to claim 7, wherein determining the learning transfer requirement information of the sample user under the respective learning task according to the ability prediction information comprises:
obtaining transfer information among different learning tasks under the respective learning task, and determining the learning transfer requirement information of the sample user according to the transfer information and the ability prediction information.

9. The method according to claim 2, wherein training and generating the course recommendation model according to the ability prediction information and the learning transfer information of the sample user comprises:
decoding the ability prediction information of the sample user to obtain probability distribution information of the ability label data;
determining a loss function of the ability label data according to the probability distribution information, and determining a loss function of the record data according to the learning transfer information of the sample user; and
training and generating the course recommendation model according to the loss function of the ability label data and the loss function of the record data.

10. The method according to claim 2, wherein determining the ability prediction information of the sample user according to the ability label data of the sample user comprises:
encoding the ability label data of the sample user to obtain coding information; and
performing a full connection processing on the coding information to obtain mean information and variance information, and performing a sampling processing on the mean information and the variance information to obtain the ability prediction information of the sample user.

11. The method according to claim 3, wherein determining the learning transfer information of the sample user according to the ability prediction information of the sample user and the record data comprises:
determining learning transfer requirement information of the sample user under respective learning task according to the ability prediction information, and determining the learning transfer information of the sample user according to the record data and the learning transfer requirement information.

12. The method according to claim 3, wherein training and generating the course recommendation model according to the ability prediction information and the learning transfer information of the sample user comprises:
decoding the ability prediction information of the sample user to obtain probability distribution information of the ability label data;
determining a loss function of the ability label data according to the probability distribution information, and determining a loss function of the record data according to the learning transfer information of the sample user; and
training and generating the course recommendation model according to the loss function of the ability label data and the loss function of the record data.

13. The method according to claim 3, wherein determining the ability prediction information of the sample user according to the ability label data of the sample user comprises:
encoding the ability label data of the sample user to obtain coding information; and
performing a full connection processing on the coding information to obtain mean information and variance information, and performing a sampling processing on the mean information and the variance information to obtain the ability prediction information of the sample user.

14. The method according to claim 4, wherein determining the learning transfer information of the sample user according to the ability prediction information of the sample user and the record data comprises:
determining learning transfer requirement information of the sample user under respective learning task according to the ability prediction information, and determining the learning transfer information of the sample user according to the record data and the learning transfer requirement information.

15. The method according to claim 4, wherein training and generating the course recommendation model according to the ability prediction information and the learning transfer information of the sample user comprises:
decoding the ability prediction information of the sample user to obtain probability distribution information of the ability label data;
determining a loss function of the ability label data according to the probability distribution information, and determining a loss function of the record data according to the learning transfer information of the sample user; and
training and generating the course recommendation model according to the loss function of the ability label data and the loss function of the record data.

16. The method according to claim 4, wherein determining the ability prediction information of the sample user according to the ability label data of the sample user comprises:
encoding the ability label data of the sample user to obtain coding information; and
performing a full connection processing on the coding information to obtain mean information and variance information, and performing a sampling processing on the mean information and the variance information to obtain the ability prediction information of the sample user.

17. A method for course recommendation, comprising:
obtaining learning data of a user; and
inputting the learning data into a pre-trained course recommendation model, and outputting a course recommended to the user, wherein the course recommendation model is trained and generated based on the method according to claim 1.

18. The method according to claim 11, wherein when the learning data comprises record data and does not comprise ability label data, inputting the learning data into the pre-trained course recommendation model, and outputting the course recommended to the user comprises:
determining the ability label data of the user according to the record data, and determining a learning feature of the user according to the record data and the ability label data of the user; and
inputting the learning feature of the user into the course recommendation model, and outputting the course recommended to the user.

19. An electronic device, comprising:
at least one processor;
a memory connected with the at least one processor; wherein
the memory stores instructions executable by the at least one processor, and the instructions are executed by the at least one processor to enable the at least one processor to: obtain a sample data set, wherein the sample data set comprises user learning data, the user learning data comprises record data and ability label data, the record data is used for representing a historical learning process of a sample user, and the ability label data is used for representing a learning ability level of the sample user; and
train and generate the course recommendation model according to the user learning data, wherein the course recommendation model is used for recommending a course for a user.

20. A non-transitory computer readable storage medium that stores computer instructions, wherein the computer instructions are used to enable a computer to:
obtain a sample data set, wherein the sample data set comprises user learning data, the user learning data comprises record data and ability label data, the record data is used for representing a historical learning process of a sample user, and the ability label data is used for representing a learning ability level of the sample user; and
train and generate the course recommendation model according to the user learning data, wherein the course recommendation model is used for recommending a course for a user.
